(19) United States
(12) Patent Application Publication
(10) Pub. No.: US 2025/0355719 A1
(43) Pub. Date: Nov. 20, 2025

(54) TRACE-DRIVEN CALL DEPENDENCY-SET AWARE PROACTIVE COORDINATED DISTRIBUTED AUTO-SCALING FOR RESOURCE MANAGEMENT

(71) Applicant: INTERNATIONAL BUSINESS MACHINES CORPORATION, ARMONK, NY (US)

(72) Inventors: Pavithra Harsha, Pleasantville, NY (US); Shivaram Subramanian, Frisco, TX (US); CHITRA SUBRAMANIAN, Mahopac, NY (US)

(21) Appl. No.: 18/668,102

(22) Filed: May 17, 2024

(51) Int. Cl. G06F 9/50

(52) U.S. Cl. CPC G06F 9/505

(57) ABSTRACT

A computer-implemented method for trace-driven dependency-set-aware proactive coordinated autoscaling of component microservices in an application includes generating performance-resource elasticity models at a trace-level for traces of the application using dependency set of microservices for each trace. The method predicts workload levels of each of the traces, and also predicts a trace-level performance of the application for different microservice replica scaling based on the dependency set of microservices for each trace, performance-resource elasticity models and the predicted workload levels. The method uses distributed computing to recommend a microservice replica scaling for each of the component microservices to meet one or more predefined trace-level user service level objectives.

### BACKGROUND

The present disclosure generally relates to systems and methods for managing resources for microservice-based and serverless (Function-as-a-Service) applications, and more particularly, to a trace driven call dependency-set-aware proactive coordinated horizontal pod autoscaling for resource management.

Microservices-based applications involve scaling of resources belonging to each component microservice; however, users experience the application performance at the aggregated “trace” level, that is the end-to-end user transaction level, for the front end application.

Autoscaling relates to the problem of the dynamic right-sizing of compute resources to support user workload. Autoscaling in microservices-based applications attempt to determine the most efficient scale of resources belonging to each component microservice to meet the service level objectives (SLOs) set by users for end-to-end user transactions or traces.

Current autoscaling methods in practice (i) involve users to set SLOs at the microservice level, and (ii) perform resource scaling of individual microservices.

### SUMMARY

A system, method and computer program code are described that provide a computer-implemented method for trace-driven dependency-set-aware proactive coordinated autoscaling of component microservices in an application that includes generating performance-resource elasticity models at a trace-level for traces of the application using distributed computing. The method predicts workload levels of each of the traces, and also predicts a trace-level performance of the application for different microservice replica scaling based on the performance-resource elasticity models and the predicted workload levels. The method recommends a microservice replica scaling for each of the component microservices to meet predefined trace-level user service level objectives.

In some embodiments, the method further includes receiving, at a user interface, one or more of the predefined trace-level user service level objectives, potentially even with different statistical measures (for example, quantile, superquantile, mean, or the like).

In some embodiments, the trace-level service level objectives include at least one of latency or throughput targets.

In some embodiments, the performance-resource elasticity models predict performance at each of the traces as a function of a vector of loads to all other traces.

In some embodiments, the performance-resource elasticity models predict performance at each of the traces as a function of resources of all of the component microservices on the traces of the application.

In some embodiments, the method further includes using a machine learning model for generating the performance-resource elasticity models.

In some embodiments, the predicted workload levels are based on a predicted load, a currently observed load, or a combination thereof.

In some embodiments, the method further includes using a machine learning model for generating the predicted workload levels.

In some embodiments, the method further includes leveraging column-generation based optimization with trace optimization in a sub-problem level and across each of the traces jointly in a master-problem.

In some embodiments, the method includes replica coordination constraints across microservices.

In some embodiments a feasible replica solution at the trace level can contribute to non-linear reward/cost to the master problem.

In some embodiments, the method further includes learning a pattern of cascading calls to predict workload levels across multiple traces.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 shows a microservice architecture showing traces between endpoints of various services therein;

FIG. 2 shows a system block diagram for trace-driven call dependency-set-aware proactive coordinated horizontal pod autoscaling for resource management, consistent with an illustrative embodiment;

FIG. 3 shows a graph for performance-resource elasticity models, consistent with an illustrative embodiment;

FIG. 4 shows a flow chart for latency prediction for the trace T with front end endpoint Te that connects to services denoted by TSi where i is an index;

FIG. 5 shows a technical solution flow chart illustrating a distributed computing based horizontal autoscaling system, consistent with an illustrative embodiment;

FIG. 6 shows a service replica graph for a column generation approach, consistent with an illustrative embodiment;

FIGS. 7A and 7B show a cart-add trace latency comparison between column-generation (CG) based coordinated, end-point model based coordinated, uncoordinated and K8s utilization based horizontal pod auto-scaling (HPA);

FIG. 8 shows a flow chart illustrating an overall process for trace-driven call dependency-set-aware proactive coordinated horizontal pod autoscaling for resource management, consistent with an illustrative embodiment; and

FIG. 9 is a functional block diagram illustration of a computer hardware platform that can be used to implement the method for trace-driven call dependency-set-aware proactive coordinated horizontal pod autoscaling for resource management, consistent with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

As described in greater detail below, embodiments of the present disclosure provide systems and methods that can provide a trace-driven call dependency-set-aware proactive coordinated autoscaling of component microservices in an application.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may determine the number of replicas needed for a given microservice so that an application (that runs one or more of the microservices) can be executed within the service level objectives (SLOs) provided by a user. This may have the technical effect of allowing users to set SLOs at the “trace” level (for the overall application that uses one or more of microservice components) and use machine learning (ML) methods to determine resource allocation of all microservices to perform proactive coordinated autoscaling for meeting these SLOs, thus minimizing violations. Accordingly, the system and methods according to embodiments of the present disclosure provide a substantial improvement to technology and computer functionality.

It should be appreciated that embodiments of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

Embodiments of the present disclosure can provide systems and methods for users to set SLOs at the trace level while use machine learning (ML) methods determine resource allocation of all microservices to perform proactive coordinated autoscaling for meeting these SLOs, thus minimizing violations.

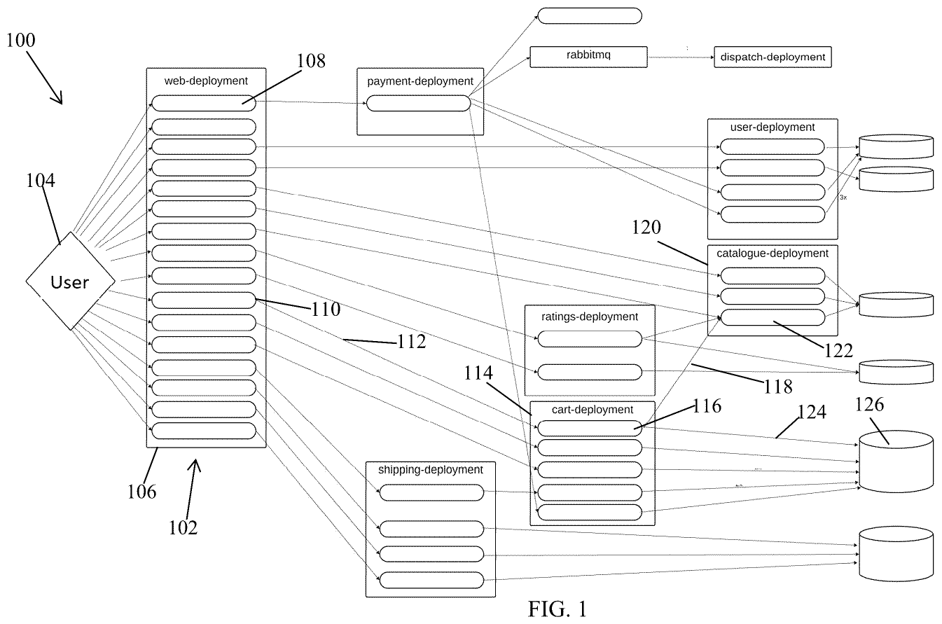

Referring to FIG. 1, a microservice architecture 100 is shown that includes a front end 102 that is accessible to a user at a user interface 104. The front end 102 can be a front end service 106 that includes a plurality of front end endpoints 108. One such endpoint may be a cart_add endpoint 110, which generates an internal call 112 to the cart-deployment microservice component 114 and, namely, the add endpoint 116 of the cart-deployment microservice component 114. The add endpoint 116 generates a first internal call 118 to the catalogue-deployment microservice component 120, namely, to the product endpoint 122 of the catalogue-deployment microservice component 120, and a second internal call 124 to a database 126. The entire end-to-end path, starting from the user call to endpoint 110, and the sequence on internal calls (112, 118, 124), together constitute a single trace.

The latency observed by the user, at the trace level, is the net latency at the front end endpoint as a result of calls to down-stream chain of endpoints on the trace based on the topology graph. For example, the cart_add endpoint 110. The trace level latency may be an aggregation of the self-latencies of each of the individual endpoints of the services on the trace used in the application. On the contrary, a microservice latency is an aggregation of multiple call types going to different endpoints in the microservice, where individual endpoints can vary by orders of magnitude in latency. As described earlier, each trace chains together different endpoints in a microservice. The cumulative latency of the frontend endpoint that is of interest to the user and is available via application performance monitoring (APM) tools is influenced by calls to other downstream endpoints. Some APM tools may report self-latencies, which is the isolated endpoint latency without any downstream contributions, may be leveraged but no specific method of aggregation of self-latencies to obtain trace latency is required for our proposed method.

Embodiments of the present disclosure provide methods for resource allocation that can use ML methods to determine resource allocation of all microservices to perform proactive coordinated autoscaling for meeting one or more end-to-end user transaction SLOs. In general, the method of implementation can include offline steps, runtime observations and runtime inferences.

As discussed in greater detail below, the offline steps include (1) extracting trace dependency set for all API calls (front end endpoints) to an application; In other words, for each of the frontend endpoints 108, the trace dependency set can be determined. In the example trace described above, starting from the cart_add endpoint 110, the trace dependency set includes the microservices 114 and 120. (2) generating performance-resource elasticity model for the frontend microservice traces; (3) generating a workload calls/sec prediction model. Runtime observations include (1) calls/sec to the front end microservice endpoints; and (2) user SLO requirements. The runtime inference includes a trace-level latency prediction and a recommended microservice replica autoscaling decision.

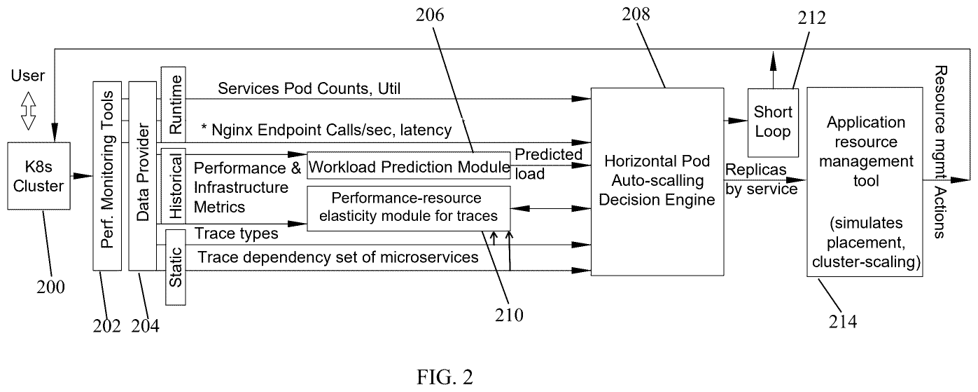

Referring to FIG. 2, an Kubernetes cluster 200 may receive input calls from the user. The Kubernetes cluster 200 may provide the front end 102 as described in FIG. 1, including front end services 106 and endpoints 108 for these services. An application monitoring and alerting tool 202, such as Instana, along with infrastructure monitoring tools like Prometheus using cadvisor, may interface with the Kubernetes cluster 200. A data provider 204 may manage the data required for embodiments of the present disclosure. The data provider 204 provides certain predetermined data, including trace types, services list (along with those that are horizontally scalable or not), services mapped to each trace type (dependency set aware but not a topology graph or call graph), historical data, the number of replicas by service, cumulative latencies by front end endpoint of trace type, and calls.per_second at the front end endpoint by trace type.

The data provider 204 can gather data during use of the system and process the data according to a trace level end-to-end performance model method, as discussed in greater detail below.

The workload prediction module 206 can receive performance and infrastructure metrics and provide a predicted load to the HPA decision engine 208. The output of the workload prediction module 206 is workload prediction at the front-end endpoint for each trace type.

When multiple traces belong to a front end call, probabilistic trace level workload estimation can be done. Similarly, a front end call to one trace could predict an upcoming increase in calls to other traces, as part of expected user behavior. These patterns of cascading calls can be observed and learned by the workload prediction model 206 and used for pro-active coordinated autoscaling.

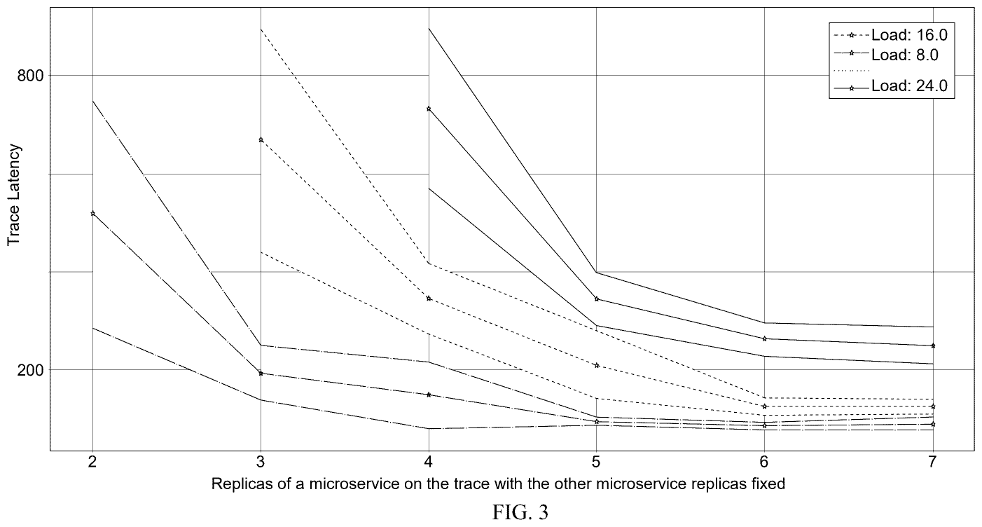

Referring also to FIG. 3, the performance-resource elasticity module 210 can determine system elasticity. Elasticity is the change in performance (latency, throughput, resource utilization, or the like) with respect to unit change in resources. The performance-resource elasticity module 210 can predict performance with change at the trace level so that it is dependency set aware. The performance-resource elasticity module 210 can use a trace level end-to-end performance model, where causal features are the load vector of all traces (at the front end endpoint) and replicas of all services on the trace. The performance-resource elasticity module 210 can leverage supervised learning AI/ML methods in python, for example, to estimate these models.

FIG. 3 illustrates performance-resource elasticity data for loads of 8.0, loads of 16.0 and loads of 24.0. This example graph shows the trace latency as compared to the number of replicas of a service for a given load when all the other services have their replicas fixed.

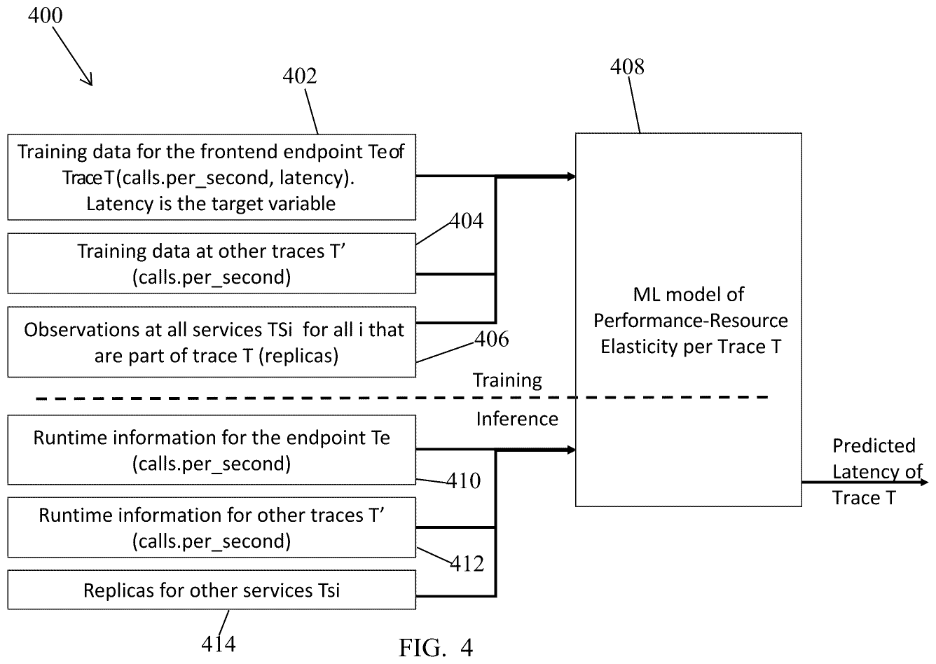

FIG. 4 illustrates a flow charts 400 for latency prediction for the trace T with front end endpoint Te that connects to services denoted by TSi where i is an index. During training, at block 402, the ML model of performance-resource elasticity per trace 408 can receive training data for the frontend endpoint Te, such as calls.per_second and latency. Further, in training, at block 404, the ML model of performance-resource elasticity per trace 408 can receive training data at other traces T′, such as calls.per_second. Finally, in training, at block 406, the ML model of performance-resource elasticity per trace 408 can observe the number of replicas at all services Tsi for all services i that are part of the trace T. At inference, as shown in blocks 410 and 412, the ML model of performance-resource elasticity per trace 08 can receive the runtime data for the endpoint Te, such as calls.per_second, and runtime data for other traces T′, such as calls.per_second. Finally, at inference, at block 414, the ML model of performance-resource elasticity per trace 408 can observe the number of replicas at other services Tsi. The ML model of performance-resource elasticity per trace 408 can output a predicted latency of trace T for load distribution and replica combination across microservices.

The HPA decision engine 208 can have a goal to optimize the resources provided, i.e. minimize total resources or penalize over/under utilization, subject to meeting all the trace level SLOs. Using elasticity models and proactive endpoint load prediction as inputs, the HPA decision engine 208 can find the coordinated scaling actions across services to meet trace level SLOs. Optimization is done at the level of overlapping traces and does not require a fully centralized solution. The HPA decision engine 208 can leverage a column generation (CG) approach that iteratively solves a master and subproblem, where the subproblem is a trace level problem yielding feasible SLO-feasible replicas by trace, and the master combines these partial solutions (columns) and imposes service-level coordination across traces. While the discussion herein focuses on latency, it should be understood that embodiments of the present disclosure may be applied to any statistical SLO metric.

The HPA decision engine 208 can use a short loop 212 to provide direct feedback to the Kubernetes cluster 200. In some embodiments, the replica recommendation may be delivered to an Application Resource Management Tool (like Turbonomic) module 214 that can help ensure full stack cost/resource optimization, application performance, and continuous health while delivering the replica recommendation to the Kubernetes cluster 200.

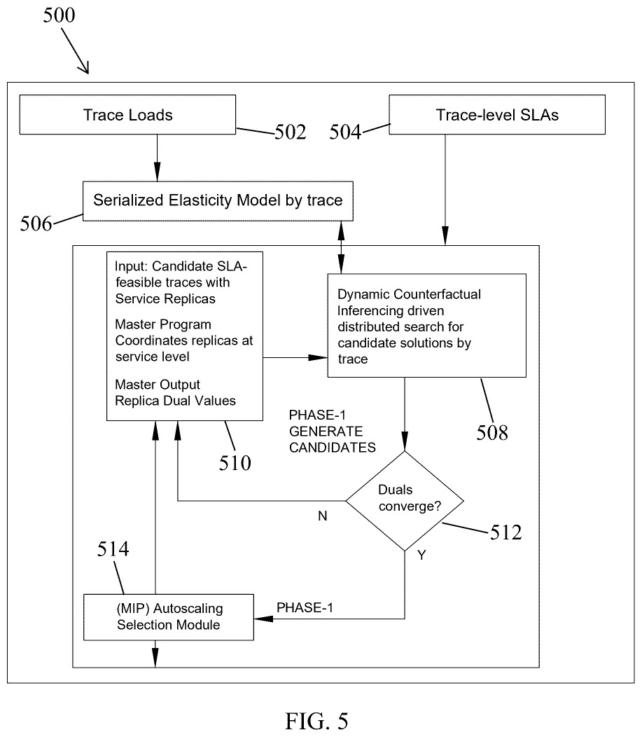

The HPA decision engine 208 can use a column generation (CG) approach methods to identify the optimal replicas of all microservices to meet trace-level SLO while maximizing resource utilization, given the performance elasticity model. FIG. 5 provides a block diagram 500 illustrating how the HPA decision engine 208 can use CG. Inputs can include trace loads 502, trace-level Service Level Objectives (SLOs) as part of Service Level Agreements (SLAs) 504 and a serialized elasticity model by trace 506. As discussed in detail below, the subproblem, at block 508, can identify one or more SLO feasible negative reduced cost paths (‘traces with replicas’) on the replica network via dynamic counterfactual inference driven search using distributed computing for candidate solutions by trace. The master program, identified at block 510, combines these partial solutions (columns) and imposes service-level coordination across traces. The output of the master program can be replica dual values, where, upon convergence, as determined at block 512, are output to the autoscaling selection module 514.

An application, as used herein, is described a directed acyclic graph G whose nodes represent (HTTP) endpoints. An edge ∈ from endpoint e₁ to endpoint e₂ means that e₁ sends requests to e₂. Each endpoint e belongs to a service s, where a service can have multiple endpoints. The set of all services in the application is denoted as S. The set of endpoints belonging to service s is denoted as Eₛ. Typically, applications have (at least) one service that acts as the front end of the application, meaning that the endpoints of this service are called from external sources (i.e. users). For simplicity, it can be assumed in the following that there is only one frontend service f. Let Er be the set of endpoints of frontend service f. Per definition, each endpoint e∈E_{f} has an indegree of 0. A trace t is defined as a sub-tree in G with two characteristics: (i) t's root is e∈E_{f} and (ii) t includes all nodes in G reachable from e. The set of all traces in the application is denoted as T. It should be noted that a user query on a trace is like a business transaction and goes to every endpoint on this sub-tree. Also, it should be noted that traces can be interpreted as sub-trees because of acyclic character of G. However, G is not necessarily a tree itself, meaning that one node (endpoint) can be part of multiple traces.

One goal in horizontal auto-scaling is to decide the replicas nₛ for all services s∈S in the application so that the latency of various traces are below the the user specified service-level objectives (SLOs) for each trace type, denoted by SLOₜ ∀t∈T (or over a combination of traces).

Dependency-set aware autoscaling, as described below, does not require knowledge of the call graph. A column generation (CG) approach can be used to analyze the auto-scaling problem when it is important to satisfy the following model requirements: (1) capture the nonlinear interactions across features in latency predictions (a global prediction model, e.g., Lt (A, n_{S(t)}) where latency of trace t is a function of arrival vector A and replicas of services S(t) associated with trace t), (2) capturing complex statistical measures of latency SLO at the trace level such as quantile, superquantile, median, or the like, where it is not obvious how to aggregate self-latencies to this aggregate notion. CG is an advanced optimization technique that effectively decomposes the auto-scaling mixed integer programming (MIP) into a master program and subproblem that are repeatedly solved until convergence is established. This decomposition approach enables one to address all two aforementioned goals while still solving a linear MIP model.

The subproblem focuses on a ‘path-level problem’ and generates improving SLO-feasible replicas (partial solutions), i.e., each partial solution represents a ‘trace with replicas’ that can be computed independently by trace.

The master program takes these partial solutions (also known as columns) as binary decision variables and aims to find an optimal combinations of columns that yield a globally feasible and near optimal or near optimal solution that can also satisfy additional system level constraints and goals. Specifically, it is desirable to ensure that, for every service, all traces that traverse the endpoints corresponding to that service have the same number of replicas.

Consider binary decision variables Xᵢₜ associated with trace t that assign a fixed number of replicas

$${m}_{it}^{s}$$

at its traversed services s∈S(t). Auxiliary continuous decision variables nₛ are introduced for every service to represent the output replica count for service s. Consider a subset of all such possible X, and denote the resultant master formulation as the restricted master program (RMP). It should be noted that latency calculations are only visible to the subproblem and are entirely abstracted out of the master program. In other words, the CG approach can work with any type of latency prediction model (e.g., endpoint level or trace level) and any nonlinear metric used to quantify the prediction uncertainty.

$$RMP : {min}_{{X}_{it} , {u}_{t} , {n}_{s} \geq 0} {\sum }_{s ∈ S} {α}_{s} {n}_{s} + {\sum }_{t ∈ T , i ∈ {I}_{t}} {β}_{it} {X}_{it} + {\sum }_{t ∈ T} {M}_{1} \cdot {u}_{t} \qquad ( 1 )$$

$${\sum }_{i ∈ {I}_{t}} {X}_{it} + {u}_{t} = 1 ∀ t ∈ T \qquad ( 2 )$$

$${\sum }_{i ∈ {I}_{t}} {m}_{it}^{s} {X}_{it} \leq {n}_{s} ∀ s ∈ S ( t ) , t ∈ T \qquad ( 3 )$$

$${X}_{it} ∈ \{ 0 , 1 \} ∀ i ∈ {I}_{t} , t ∈ T \qquad ( 4 )$$

The objective minimizes a weighted replica count (weighted by resources usage, for example) as well as other trace specific objectives including utilization, latency goal slack and/or violation. It should be noted that if there are services level objectives like utilization of a service, the βᵢₜ coefficient is divided with τₛ which is the number of traces that touch service s. The first set of constraints ensure that every trace (with replicas) is considered in the optimal solution and eliminates the trivial solution X=0. The second set of restrictions ensure that all traces have the same number of replicas for a given service they touch. In this master program formulation, feasibility of the optimal solution can be assured by solving a mini-max problem to minimize the maximum replica value for each service as a higher replica for any service will not violate latency constraints.

The CG algorithm proceeds as follows: (1) Generate: The subproblem identifies one or more SLO feasible negative reduced cost paths (‘traces with replicas’) on the replica network. This reduced cost can be computed as:

$${β}_{it} - {π}_{t} - {\sum }_{s ∈ S ( t )} {μ}_{st} {m}_{it}^{s} ,$$

where

$${m}_{it}^{s}$$

=number of replicas for service s in path t, πₜ=value of dual variable associated with constraint (Eqn, 2) μₛₜ=values of dual variables associated with constraints (Eqn. 3). It should be noted that μₛₜ≤0 and is 0 if the constraint is not tight. The sign constraints for πₜ are unknown because it is equality cosntraint. (2) Solve LP Dual: The dual values (π,μ) are obtained by solving the linear programming (LP) relaxation of the master program by replacing the binary restriction with X≥0. (3) Solve MIP (Select Phase): Once the dual values converge, the CG can be stopped, the binary restrictions can be reimposed and the MIP can be solved directly using CPLEX to select the best feasible combination of replicas. A ‘branch-and-price’ technique can also be employed to solve large scale complex MIPs. This latter issue is relevant when the gap between the MIP solution and its LP relaxation is wide.

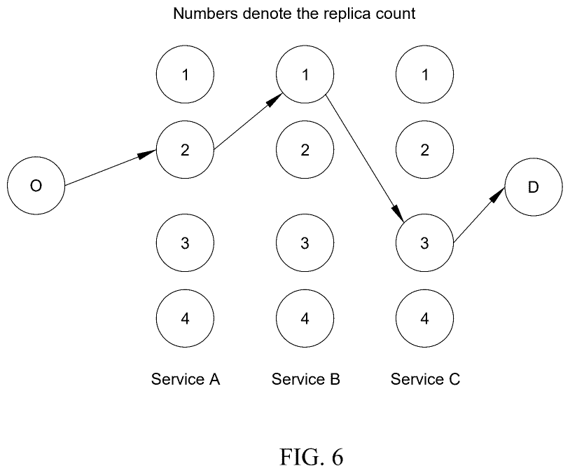

One component of CG is that it gives the approach enormous flexibility in practice is the subproblem in step (1). This can be solved heuristically as a resource constrained shortest path (RCSP), or exactly by implicitly considering all feasible candidates and can be executed using distributed computing, which is critical for large-scale systems that process a large number of traces (hundreds or thousands). One can choose to construct a separate graph for each trace and the discussion below assumes a separate graph for each trace. The RCSP algorithm is path-setting shortest path implementation executed on a service-replica graph (FIG. 6) that considers path-dependent quantities that are non-separable. The subproblem aims to find the most negative reduced cost latency-feasible source-sink path for each trace and add it to the RMP. In practice, we add not just one, but some K best paths to the RMP to accelerate convergence.

Consider a graph Gₜ(V,E) for a trace t, where (V,E) represents the sets of nodes and edges, respectively. A node denotes a (service, number of replicas) tuple. Arcs are only constructed between nodes belonging to different services. A source O and sink D node are introduced to denote the start and end of all OD-paths in Gₜ. Nodes for a given service are ordered vertically, and services are laid out horizontally. This setup implicitly contains all possible service-replica combinations for a trace. A plain-vanilla version of RCSP is described below. The approach is flexible and accommodates a variety of additional business requirements and user preferences. Unlike the standard shortest-cost path algorithms where costs are additive across nodes and can be stored on the arcs, here the cost of a path need not be additive or separable across its nodes.

Step 1, Ordering: Pre-arrange the order in which the nodes in Gₜ are visited. For example, order services from left to right and increasing replicas from top to bottom. It may be desirable to order the services by the larger time contribution to the trace so that one can quickly eliminate the replica combinations that do not work. Store the corresponding node indices in a static list (0, . . . , |V|−1) that will be used for all CG iterations. Initialize the current node index i=0, corresponding to the source node. Store the path set P₀=0 at the source node. If it is desired to store full paths, P₀ can represent the current set of replicas, i.e., the current replica state of trace t, if this is feasible. Alternatively, a base feasible path can be chosen, for example the max replicas for all services.

Step 2, Labeling node (i): To set the label for node (i) (meaning node i will not be visited again in the algorithm), the paths in Pᵢ are extended to all the nodes (j) belonging to the next service that are directly connected to node i. The feasibility of the predicted latency of the trace for the resultant replica combination is verified and the extension is discarded if it is infeasible. It should be noted that if node (j) yields a feasible extension, all nodes below node (j) (which have higher replicas), will naturally be latency-feasible. The extended path is added to the path list at node (j). At any point, no more than the K′-best reduced-cost paths are retained at any non-sink node. If a negative reduced cost path is obtained during this extension, this path is also added to the path list at the sink node (only storing the K-best paths at the sink node).

Step 3, Set i=i+1. If i corresponds to the the sink node, stop and add the paths stored in the sink node as columns to the RMP, else go to step 2.

RCSP with Trace-level prediction models: At every such extension, the prediction model's inferencing function is invoked to obtain the latency and utility prediction. For trace-level prediction models, inferencing simply uses the existing/max replica count for yet-to-be-visited service nodes, if the current replica solution is feasible or work with a base solution like max replicas for all services. For example in Step (1) at the source node, the single path in P₀=0 would be scored using the existing/max replica count at each service of the trace. Thereafter, at any intermediate node, the prediction model uses the existing/max replica count for yet-to-be-visited service nodes for scoring. In this setting, one always has a full view of the trace as metrics for the entire trace are calculated at every extension. In other words, the path set Pᵢ at every node always contain complete paths and we can add negative reduced paths among them to the path list at the sink node.

RCSP with Self-latency models: When self-latency predictions are available at each service that allows for separability, then the intermediate path calculations become more efficient as one can estimate the latency for a partial path, and invoke the ‘trace-level’ prediction model to recalculate the latency at the sink node. Feasibility checks can be performed at every path extension (optionally) or only at the sink node when the full trace is available.

Alternatives to RCSP are possible for less complex traces. It should be noted that the path search-space grows exponentially in the number of different services touched by per trace. If the vast majority of the traces (say, 95%) have only a few hops (touching no more than three services), then all replica combinations can be enumerated (by trace), and a feasibility check can be performed to retain all the latency-feasible paths. This task can be parallelized across traces. Thereafter the CG approach can solve the subproblem (1) exactly by identifying the path having the most negative reduced cost and adding it to the master program. It should be noted that adding a column to the master program is equivalent to introducing an additional binary decision variable. A theoretical advantage of solving the subproblem exactly is that the optimal LP solution obtained when the CG algorithm converges will be a guaranteed lower bound on the final (discrete) optimal solution, which gives us a certificate of quality.

Additionally, if the number of traces is also relatively small, then the entire pool of feasible traces can be added to the master program, skip the iterations between steps (1) and (2), proceed directly to step (3).

On the other hand, if traces touch several services and there are a lot of traces, then the RCSP approach is often the only viable option as the exploding number of combinations and binary variables may render the problem intractable. The RCSP approach precludes theoretical guarantees but quickly converges to near-optimal solutions in practice. A reason is that real-world subproblems typically lack the ‘integrality property’ (i.e., yielding integral solutions). RCSP Convergence is accelerated by finding a near-optimal set of negative reduced cost paths in each subproblem iteration and terminating when we have a sufficiently good candidate pool.

Master Program Solution Approaches and Alternatives: It should be noted that one only requires good quality feasible dual solutions to the relaxed RMP model for the CG algorithm to progress. While there are various techniques available to achieve this goal, the most convenient approach is to simply invoke the CPLEX LP solver and warm start from the previous solution. The final MIP can also be directly solved using a CPLEX-MIP solver.

The subproblem enables the business user to work with practically any linear or non-linear objective function, as well as complex constraints such as meta-rules. Typically, such meta rules cannot be efficiently reformulated as linear constraints (MIPs) or even as soft constraints using continuous penalty functions (e.g., reinforcement learning neural networks). In such situations, the nonlinearities are entirely processed within the subproblem, and enter the master program as fixed numerical input coefficients, and therefore the master program structure remains linear. Furthermore, the approach is agnostic to the choice of the prediction model. As a result, the CG framework may be useful for managing a wide variety of use cases beyond auto-scaling.

It should be noted that latency is as a result of some resources being over-utilized. Latency can be modeled as a function of resource utilization (which is ratio of usage to capacity) instead of replicas. In this approach, the amount of usage also needs to be predicted with workload and the utilization is obtained using this usage and the number of replicas and then the mapping between latency and replicas can be leveraged in the optimization model.

Alternative approaches may be contemplated within the scope of the present disclosure. For example, alternative approaches can be used for prediction performance. It should be noted that instead of modeling performance as a function of load and replicas directly in one step, there can be alternative two-steps methods. For example, performance can be modeled as a function of resource headroom (capacity minus consumption) or utilization (consumption over capacity) and load resulting in change in resources consumed. Using the fact that the capacity is replicas * unit capacity, utilization and headroom can be estimated. This two-step approach also ultimately predicts performance with change in load and replicas. There can be other choices as well to leverage current utilization levels to model transients and/or alternatively combine both utilization/headroom and replicas

Further, alternative approaches can be taken for decision optimization. The model could combine observed load and predicted load in various ways to query the performance model. For example, the model could use the higher of the two to be conservative. These models can be modified to explore actions using Thompson sampling (or other bandit or RL methods; e.g., one simple approach is to bootstrap historical data to generate predictions and respective optimal action; select any of these uniformly) to enhance the speed of the learning capability of the elasticity models. This can be used if the historical data does not have variations to build out a robust causal relationship. This approach can always be done in combination with a traditional approach, for example use the latter as a fallback mechanism when the data for inferencing is bad.

### Results

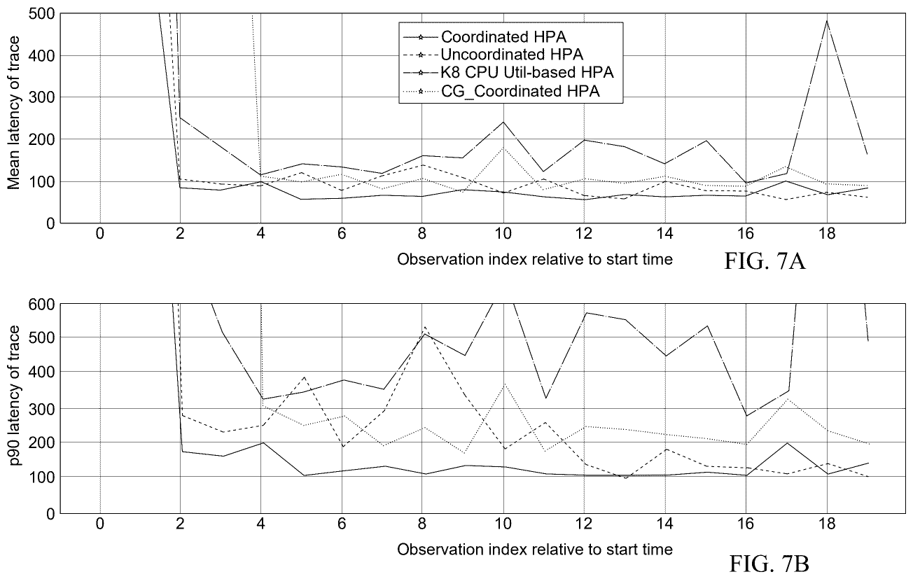

Referring to FIGS. 7A and 7B, the cart-add endpoint trace latency is compared between CG_coordinated HPA, according to embodiments of the present disclosure, coordinated HPA, uncoordinated HPA and Kubernetes' utilization-based HPA. As can be seen, the CG_coordinated HPA provides excellent results in terms of both mean latency of the trace (FIG. 7A) and the p90 latency of the trace (FIG. 7B).

### Example Process

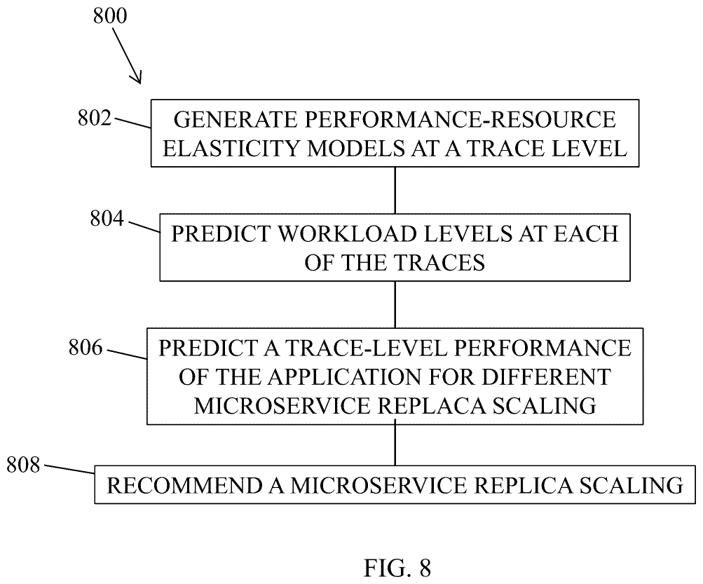

It may be helpful now to consider a high-level discussion of an example process. To that end, FIG. 8 presents an illustrative process 800 related to the method for trace-driven dependency-set-aware proactive coordinated autoscaling of component microservices in an application. Process 800 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

Referring to FIG. 8, block 802 of process 800, can include an act of generating performance-resource elasticity models at a trace-level for traces of the application. The process 800, at block 804, can predict workload levels of each of the traces. At block 804, the process 800 can predict a trace-level performance of the application for different microservice replica scaling. Finally, at block 806, the process 800 can recommend a microservice replica scaling for each of the component microservices to meet predefined trace-level user service level objectives.

### Example Computing Platform

Various embodiments of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

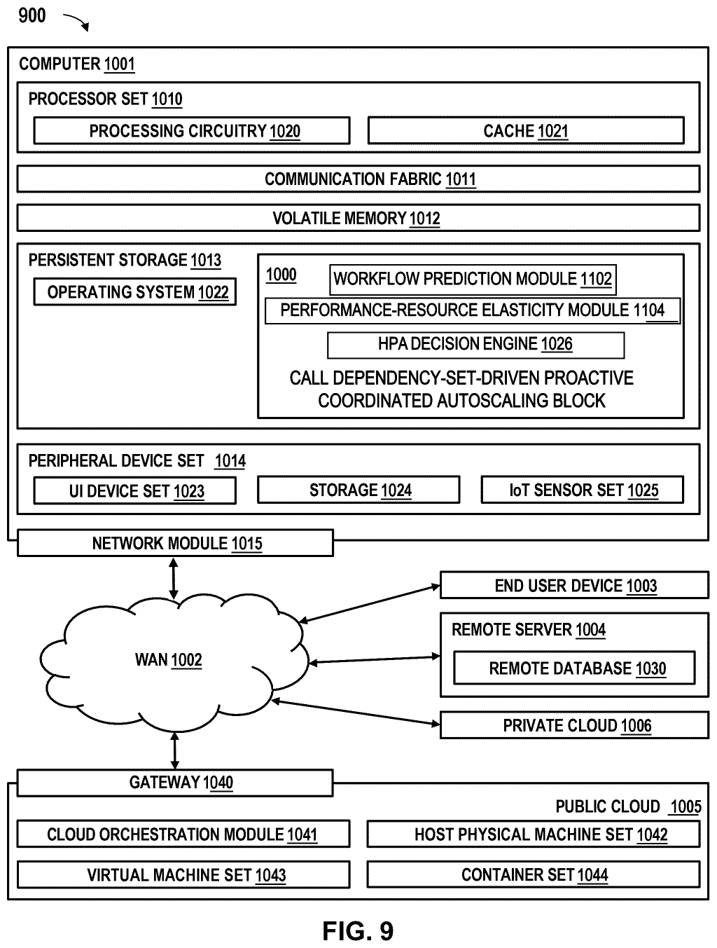

Referring to FIG. 9, computing environment 900 includes an example of an environment for the execution of at least some of the computer code involved in performing the inventive methods, including trace-driven dependency-set-aware proactive coordinated autoscaling block 1000, which can include a workload predication module block 1102, a performance-resource elasticity module block 1104 and a HPA decision engine block 1026. In addition to block 1100, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1100, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 9. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1100 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in block 1100 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Embodiments of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement features of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for trace-driven dependency-set-aware proactive coordinated autoscaling of component microservices in an application, the method comprising:
generating performance-resource elasticity models at a trace-level for traces of the application using a dependency set of microservices for each trace;
predicting workload levels of each of the traces;
predicting a trace-level performance of the application for different microservice replica scaling based on the dependency set of microservices for each trace, performance-resource elasticity models and the predicted workload levels; and
recommending a microservice replica scaling for each of the component microservices via distributed computing to meet predefined trace-level user service level objectives.

2. The computer-implemented method of claim 1, further comprising receiving, at a user interface, one or more of the predefined trace-level user service level objectives.

3. The computer-implemented method of claim 1, wherein the performance-resource elasticity models predict performance at each of the traces as a function of a vector of loads to all other traces.

4. The computer-implemented method of claim 3, wherein the performance-resource elasticity models predict performance at each of the traces as a function of resources of all of the component microservices on the traces of the application.

5. The computer-implemented method of claim 1, further comprising using a machine learning model for generating the performance-resource elasticity models.

6. The computer-implemented method of claim 1, wherein the predicted workload levels are based on a predicted load, a currently observed load, or a combination thereof.

7. The computer-implemented method of claim 1, further comprising using a machine learning model for generating the predicted workload levels.

8. The computer-implemented method of claim 1, further comprising leveraging mixed-integer programming using column-generation based distributed optimization across traces with trace optimization in a sub-problem level and across each of the traces jointly in a master-problem.

9. The computer-implemented method of claim 1, further comprising learning a pattern of cascading calls to predict workload levels across multiple traces.

10. A system comprising:
a processor;
a memory coupled to the processor; and
a computer readable storage embodying a computer program code, the computer program code comprising instructions for trace-driven dependency-set-aware proactive coordinated autoscaling of component microservices in an application, wherein an execution of the instructions by the processor configure the processor to:
generate performance-resource elasticity models at a trace-level for traces of the application using a dependency set of microservices for each trace;
predict workload levels of each of the traces;
predict a trace-level performance of the application for different microservice replica scaling based on the dependency set of microservices for each trace, performance-resource elasticity models and the predicted workload levels; and
recommend a microservice replica scaling for each of the component microservices via distributed computing to meet predefined trace-level user service level objectives.

11. The system of claim 10, wherein the trace-level service level objectives include at least one of latency or throughput targets.

12. The system of claim 10, wherein the performance-resource elasticity models predict performance at each of the traces as a function of a vector of loads to all other traces.

13. The system of claim 12, wherein the performance-resource elasticity models predict performance at each of the traces as a function of resources of all of the component microservices on the traces of the application.

14. The system of claim 10, wherein the execution of the instructions further configure the processor to:
use a first machine learning model for generating the performance-resource elasticity models; and
use a second machine learning model for generating the predicted workload levels.

15. The system of claim 10, wherein the predicted workload levels are based on a predicted load, a currently observed load, or a combination thereof.

16. The system of claim 10, wherein the execution of the instructions further configure the processor to leverage column-generation based optimization with trace optimization in a sub-problem level and across each of the traces jointly in a master-problem.

17. The system of claim 10, wherein the execution of the instructions further configure the processor to learn a pattern of cascading calls to predict workload levels across multiple traces.

18. A computer program product for trace-driven dependency-set-aware proactive coordinated autoscaling of component microservices in an application, the computer program product comprising a computer readable storage medium having program instructions embodied therewith, the program instructions executable by a computer to cause the computer to:
generate performance-resource elasticity models at a trace-level for traces of the application using a dependency set of microservices for each trace;
predict workload levels of each of the traces;
predict a trace-level performance of the application for different microservice replica scaling based on the dependency set of microservices for each trace, performance-resource elasticity models and the predicted workload levels; and
recommend a microservice replica scaling for each of the component microservices via distributed computing to meet predefined trace-level user service level objectives.

19. The computer program product of claim 18, wherein the performance-resource elasticity models predict performance at each of the traces as a function of a vector of loads to all other traces.

20. The computer program product of claim 18, wherein the program instructions further cause the computer to leverage column-generation based optimization with trace optimization in a sub-problem level and across each of the traces jointly in a master-problem.
